(19) United States
(12) Patent Application Publication
(10) Pub. No.: US 2008/0290991 A1
(43) Pub. Date: Nov. 27, 2008

(54) Procedure for the determination of an authorization

(75) Inventor: Harald Luling, Meinerzhagen (DE)

Correspondence Address: JONES & SMITH, LLP, 2777 ALLEN PARKWAY, SUITE 800, HOUSTON, TX, 77019-2141, US

(73) Assignee: Burg-Wachter KG

(21) Appl. No.: 11/529,698

(22) Filed: Sep. 28, 2006

(30) Foreign Application Priority Data
Sep. 29, 2005 (DE) DE 102005046609.5
Jul. 21, 2006 (DE) DE 102006034241.0

(51) Int. Cl. G08B 29/00

(52) U.S. Cl. 340/5.82

(57) ABSTRACT

This invention relates to a method for the determination of an authorization, using at least one biometrical feature, said biometrical feature being collected by means of a sensor unit and being compared with individual-related stored data sets for this feature and leading to a result of the comparison which allows a decision on the presence of the authorization, wherein at a positive decision on the presence of the authorization the data of the collected biometrical feature are stored in an individual-related fashion as a further data set.

This invention relates to a method for the determination of an authorization, using at least one biometrical feature, in which method said biometrical feature is collected by means of a sensor unit and is compared to individually assigned data sets that are stored for this feature and leads to a result of said comparison which allows a decision on the presence of the authorization.

With increasing safety requirements and because of the use of automatic access systems, access authorizations become increasingly important, with a constantly expanding area of application. This is the result among others of an increasingly efficient data processing hardware that allows the development of increasingly ingenious control systems. Modern information technology makes it possible to provide and process enormous volumes of data and information. In many cases, however, these data and information shall be made available only for authorized access, especially when these data are confidential or contain confidential information. Of course, the same applies also to access authorizations, the presence of which is verified by access control systems in order to grant access only to authorized individuals.

Biometrical features are used to a growing extent for checking the presence of an authorization. Though it is possible to clearly identify an individual by means of a biometrical feature, this feature is still subject to some degree of uncertainty because it may experience certain alterations which are due to influences from outside or to a time-based process. Biometrical features can be collected and stored as a data set. Therefore, the use of biometrical features requires special measures in order to be able to make a reliable check for the presence of an authorization, particularly in the case of an identification and/or verification of an individual.

Identifications and/or verifications of individuals are performed to an increasing extent by using invariable or substantially invariable characteristic features of an individual. It has been known for a long time that the fingerprints of an individual are almost unique, so that normally a fingerprint, provided that it is known, may be assigned to an individual as an identification element. The same is true of the iris of an eye of an individual which also has unique structures. Accordingly, individuals may be identified and/or verified by their fingerprints and/or iris. The identification and/or verification of the individuals may be used for example in order to assign to these individuals certain rights, for example the rights for access and/or operations, so that via an identification and/or verification of the fingerprint for example an electronic locking system can be unlocked, whereby the individual having this fingerprint may gain access to a particular protected part of a building.

There are also known other biometrical features of individuals which, too may be assigned to a particular individual and used for its identification and/or verification. As an example, all those features may be mentioned which can be determined during a genetic analyses. However, in the domain of access an/or operation authorizations it is usually required to make a rapid identification or verification, at which for example the bionomical features of an individual which are to be verified must be compared to a plurality of data of different individuals that are stored in a memory. There are known data processing devices which are able to perform a huge number of arithmetical operations within a short time, so that normally an identification or verification of an individual is also possible within a short time by using biometrical features such as for example a fingerprint.

Accordingly, at the identification or verification of individuals a particular fingerprint is compared to a plurality of fingerprints which are on file. It is further known, for the verification of the identity of an individual, to take a fingerprint of this individual and to compare the same with an already previously stored fingerprint of this individual. Such verification methods serve for example for access control, for protection against abuse in the social systems and for protection against data abuse. Both for identification purposes and verification purposes computer-assisted methods are known in which is produced an image of the fingerprint in a first step. This image is then edited and thereafter subject to a feature extraction. The editing may comprise data screening, data treatment in terms of contrast, brightness and colour or the like or also further treatment. In the application for verification the extracted features are compared to the features of a particular reference image. Thereafter, the result of the comparison is output for example in the form of a signal which unlocks a locking device such as a lock. In the application for identification the fingerprint is subject to a coarse classification on the basis of the extracted features. Then the extracted features are compared to the features of a plurality of reference images stored in a corresponding data base. Here, too a result of the feature comparison is output, outputting a particular data set and with that the identity of the individual to be verified.

Normally, when producing an image of a fingerprint a colour, usually ink, is applied to the finger or the print is taken by means of a fingerprint sensor. The picture that has been taken is thereafter converted into a screen image to allow the identification or verification being performed in a computer-assisted automatic process. A drawback that has shown here is, however, that the screen image of the fingerprint is of poor quality which is due to the fact of bad taking conditions. A fingerprint has a particular papillary line structure which makes it unique. But if in a screen image individual papillary lines break, are crushed or not separated from each other, the danger of confusion with other fingerprints will increase. For this reason, it is required as a rule to subject the screen image to a an image editing process in order to improve the structure of the papillary lines for the subsequent feature extraction. Therefore, it is necessary for example that in the image editing process papillary lines are retraced, whereby the source of faults of such a method is increased.

In addition to papillary lines a fingerprint also includes minutiae which are local features in the fingerprint. Minutiae are for example ridge endings and ridge bifurcations and, differently from papillary lines, minutiae are points respectively where ridges ends abruptly.

It is also known that fingerprints are not always deposited under optimum conditions. Sometimes the fingerprint that is to be recorded can be unclear and/or altered for example by dirt or injuries on the fingertip, so that a tendency of faults may be noticed, especially at a rapid identification or verification. For example, if in a locking system a fingerprint reader is unable to uniquely assign the fingerprint of an authorized individual to this individual because of dirt or injuries on the fingertip, the locking system will remain locked and the authorized individual is not granted access. This leads to the disadvantage that the error rate which is due to minor alterations of biometrical data prevents the use of this technology to a greater extent in the field of access authorizations and especially in the field of locking systems technology. In this respect, especially changes in biometrical features due to injuries such as incisions, chemical burns and/or scarred tissue must be taken into account. In addition, the problem exists that the individual to be identified and/or verified does not always put its finger onto the reading device in the same manner, i.e. with the same orientation and/or the same pressure.

It's not only the field of locking systems where an excessively high error rate results in a reduced acceptance to an extent not allowing any large quantity production. This in turn results in the disadvantage that such systems, because of the small production quantities and the high production cost, are not widely spread.

This is where the present invention has its starting point. The invention is based on the problem of further developing a method like the one described above so that the reliability of the determination of an authorization based on a biometrical feature is increased.

In a method according to the present invention the solution of this problem provides that when the decision on the presence of an authorization is positive, the data of the collected biometrical feature are stored as a data set related to individuals, especially as a further data set in a changed or unchanged form. With the present invention it is proposed for the first time that at every procedure for collecting a biometrical feature the same is used not only for comparison with an already stored data set, but is also additionally stored. This makes it possible to remain up-to-date concerning changes of the biometrical feature and to fix permissible deviations of this feature on the basis of registered changes. The reliability of determination of the authorization can be considerably improved. The risk of rejection of a valid authorization can be considerably reduced, whereby the use of the system as intended can be clearly improved. In this way, a pre-determinable deviation of the detected biometrical feature from the data set used for comparison may be ignored, so that in dependence of a pre-determinable limit said comparison can lead to a positive result in spite of a deviation. This option makes it possible that minor deviations at the collection of the biometrical feature as well as minor deviations which are due to alterations do not cause a negative decision resulting in that an authorization although existing is not recognized. The reliability of the system when it is operated as intended can be clearly improved. Of course, the comparison may be limited to certain parts of the collected biometrical feature or may cover one or more parts. The comparison may, of course, be limited to selected partial features, for example to minutiae or the like. Also a combination of various methods of comparison may be provided. Moreover, the data set may be stored changed or unchanged. So it may be provided for example that the data set is composed of data directly delivered from the sensor unit. But it may be also provided that an edited version of such a data set is stored, in which the data are being treated as mentioned in the beginning. Also, a treatment may be provided which takes into account the stored data set on which the comparison is based.

According to an advantageous further development it is provided that the data of the collected biometrical feature are compared to several data sets of an individual that are stored for this feature. An individual may be a human being or also any other living thing, for example an animal, a plant or the like. In the pre-sent case, there are several data sets available in a stored form for one individual, for example from several different collections of one and the same biometrical feature of this individual. This feature may be a fingerprint, an iris scan or the like. The existence of several data sets from an individual makes it possible to still further improve the reliability concerning the determination of the authorization. Due to the fact that the possible pattern of construction of a biometrical feature of this individual is available from the data sets, a range of tolerances may be fixed allowing to still further improve the decision as to whether or not an authorization exists. Reliability can be increased with the number of data sets. In addition, for certain partial features of the biometrical feature different probability densities may be determined which make it possible to still further increase the reliability at proper operation.

It is further proposed that one data set for this feature be deleted. In this way it may be attained that the overall data volume is limited to a certain volume. It may be provided for example that for one individual a pre-determinable number of data sets can be stored at maximum. It may be also provided that the number of stored data sets is fixed in dependence of the individual. This is advantageous for example at the verification of the authorization of individuals, of which the biometrical feature that is to be collected shows differently strong deviations.

According to a further development it is proposed that the deletion of the data set is dependent of a match with the collected biometrical feature at the comparison. If the comparison shows for example that the collected biometrical feature slightly differs from an earlier data set, it may be provided that the data set is replaced by the collected biometrical feature. In this way, an automatic updating of the determination of an authorization is possible. But it may be also provided that a data set is deleted after the lapse of a certain time period or the like. Finally, it may be provided that no deletion takes place if the result of the comparison is not a deviation.

In a further development it is proposed that a data set for a biometrical feature is replaced in a fashion related to individuals by a replacement data set of a currently collected biometrical feature. Accordingly, it may be provided that the data set for the biometrical feature is replaced at regular intervals by a data set for a currently detected feature. This can be done at each collection or also at pre-determinable time intervals or collection frequencies. The conditions for the replacement of the data set may be individually predetermined. Accordingly, it may be provided for example that the data set is replaced at every fifth or every tenth detection. In addition, it may be provided that the data set is replaced every week and/or every month. Besides, it may be provided of course that a data set, for example the one that has been initially detected, is never deleted.

Moreover, it is proposed that the earliest data set that is related to individuals is replaced by the replacement data set. This improves the follow-up concerning the determination of the authorization and allows to keep the range of tolerances as narrow as possible and as up-to-date as possible. In this way it can be avoided that a very similar biometrical feature of a further individual leads to an unjustified decision about the presence of an authorization.

In a further embodiment it is proposed that the replacement data set is composed of the data set to be replaced and the data set of the collected biometrical feature. In this way a follow-up of the determination of the authorization can be obtained already automatically with the storing of the new data set. Accordingly, it may be provided for example that at the comparison with such data sets a fixed predetermined range of tolerances is provided. Reliability can be further improved. The replacing data set can be produced by mathematical operations like the mean value determination and the like from the data sets that are available or from a part thereof. Of course, there can be also provided a different weighting of individual data sets or of all data sets. The weighting may also vary for partial features.

Moreover, it is provided that from several data sets which are available for this feature one data set is determined for the comparison. The data set may be obtained for example through mathematical methods which are performed on a data processing device by means of a computer program. In this context it may be provided that the data sets are differently weighted with regard to their influence on the data set that is to be determined for the comparison. For example, a data set of a later date may have a higher weight than a data set of an earlier date. Also, in dependence of the weighting a range of tolerances for the comparison may be determined, in order to further improve the reliability during the determination of the authorization. It may be provided for example that the range of tolerances is set relatively narrow with regard to the collected data set. But a reliable determination of the authorization may nevertheless be obtained.

According to a further development it is provided that a number of the data sets related to individuals is limited. This limitation may be provided with regard to the maximum number of stored data sets, but it may provided also regarding the age of the stored data sets. Accordingly, there may provided for example a maximum storage time period for a data set, and after this time period has been exceeded this data set will be automatically deleted. In this way, it can be made sure that authorizations that have been revoked but not yet deleted will be deleted automatically by the lapse of time.

According to an advantageous further development it is provided that the data set of a collected biometrical feature is compared with an invariable data set of a separate storage unit. The reliability of the detection of the authorization can be further increased. In addition, the data set of said separate storage unit may be compared also with the stored data sets. In this way, it is possible for example to determine a data set valid for the individual, prior to making the comparison, and in this way to clearly accelerate the comparison operation, since for example only one comparison of the collected biometrical feature with only a single stored data set has to be made. The separate storage unit may be in communication with a unit for performing the comparison via a known communication connection. Said communication connection may be for example a wired communication connection like the fixed telephone network, the internet or the like, but it may also be a wireless communication connection on radio basis, like the GSM network or the like or a combination thereof. The separate storage unit may be designed for example as a ROM, an optical storage or the like, of which the properties are selected so that any attempt of altering the data set would lead to its destruction in the storage unit. The reliability can be further increased.

To further improve the flexibility of the method according to the invention it is provided that as a separate storage unit a transportable storage unit is used. This can for example be in the form of a transponder chip, a magnetic card, a chip card or the like. This is put into a communicating connection with the comparison unit, so that the comparison unit may access the data set stored in the storage unit. The storage unit may also contain several data sets which, in addition to that, may be provided for different biometrical data of the individual. Preferably, the storage unit is in the form of a chip card and can be easily carried along. It may include its own energy supply or it may be supplied with energy from the reading unit. The coupling as well as the reading of the data can be effected magnetically, electrically or optically as well as by a combination thereof.

In an advantageous development it is proposed that an initialisation data set is stored in a fashion related to individuals. Preferably, this data set is invariable and is collected by means of the sensor and stored as a biometrical feature together with the provision of the authorization. It can be the data set of a first collection of the biometrical feature. The initialisation data set is deleted for example only if the authorization is withdrawn. In this way, it can be obtained that any insidious departing of the biometrical feature from that what has been originally collected is permitted only up to a certain limit. Beyond this limit, which may be predetermined, the comparison leads to a refusal of the authorization.

According to a further embodiment it is proposed that a range of acceptance is determined from several data sets available for this feature. This range of acceptance can be composed of the identity area, in which the data set on which the comparison is based and the collected biometrical feature are determined as identical by comparison, and the range of tolerances. If the biometrical feature is within the range of acceptance, the comparison will produce a positive result with regard to the authorization. The range of acceptance can be stored as a separate data set. Moreover, the range of acceptance can include transition areas that can be determined by deviations of the different data sets. A further improvement of the reliability can be obtained.

According to one embodiment it is proposed that the comparison is made on the basis of the range of acceptance. The range of acceptance represents the totality of features which at the comparison leads to a positive decision with regard to the authorization.

In a further development it is proposed that the range of acceptance is adapted upon determination of match during the comparison, by means of the collected biometrical feature. This option makes it also possible to update the range of acceptance within the scope of pre-determinable limits and to follow-up with regard to alterations of the collected biometrical feature.

According to one proposal of the invention a biometrical feature of a human being is used as the biometrical feature. This allows the method according to the invention being commercially used in a vast range in the field of safety and/or information technology (IT). The identification of a human being as well as the verification can be automated with a high degree of reliability, with a constant quality standard being able to be attained which can be provided independently of the daily form or qualification of manually effected comparisons.

According to a further proposal the method of the invention is used for a lock control. This makes it possible to provide lock control devices in a biometrically controlled fashion, so that the key-based technology can be avoided or reduced. A biometrical lock control additionally avoids the problems in connection with the loss or theft of a key. Through available and comparatively inexpensive means a lock control is obtainable in which only authorized individuals are reliably granted access, whereas unauthorized individuals are reliably refused access. The structural possibilities as provided by the present invention make it possible with simple and known means to attain a reliability which is considerably increased as compared to known systems. For this reason lock controls of such a type become attractive and affordable also for the use in private homes.

In a further development a method is proposed for the identification and/or verification and particularly the checking of an access and/or operation authorization of at least one individual by a comparison of biometrical features of the individual, particularly at least its fingerprints and/or iris, with the data of the biometrical features of this individual that are stored in a memory, in which method the data of the biometrical features of the individual are stored in a memory as a first data set and the data of the first data set are compared at every identification and/or verification with the data that are collected during the identification and/or verification, in order to generate a signal indicating match and/or non-match of the collected data with the data of the stored data set, and in which the biometrical features of an individual which are recorded as data during the identification are stored in the data memory as data of a second data set of the biometrical features of the individual in addition to the already existing first data set, and in which at every subsequent identification the biometrical data that have been recorded during the identification are compared with at least the data of one of the stored first and/or second data sets, particularly with the last stored second to n-th data set.

Accordingly, an essential idea of the invention resides in recording a first original data set representative of the data of biometrical features of individuals which have access authorization or are authorized users. With every subsequent identification a supplementary data set is generated which is stored in addition to the original data set. In this way, the now generated data set may be compared during a subsequent identification with at least two or more already stored data sets, so that the probability of a faulty identification and/or verification is substantially reduced. The method according to the present invention provides for a learning effect, so that minor alterations of the biometrical features are stored, thereby avoiding any incorrect identification and/or verification.

So it is possible with the method according to the invention to identify and/or verify a person whose fingerprint which is taken in a subsequent data recording operation has changed as compared to the data sets already stored, due to an injury. Here, probabilities are calculated which make it possible to grant access and/or authorize use also for the event that the recorded fingerprint does not identically match the originally stored fingerprint. Any tampering with fingerprints can be detected thereby, as far as the method of the invention is used for the identification of individuals.

According to a further feature of the invention it is provided that the originally stored data of the biometrical features of the individual are stored in the data memory as the original data set, especially in an invariable and non-erasable fashion. Accordingly, this original data set represents a reference value that normally remains preserved and that is also used as a rule at every identification and/or verification. At the generation of the original data set it is of course possible that optimum conditions exist for producing the data representative of the biometrical features of the individual, for example during the recording of fingerprints. Part of these optimum conditions are the illumination and the correct orientation of the fingerprint to be recorded. It goes without saying that the recording process may be preceded by a cleaning of the fingertip, so that any contaminations can be excluded.

According to the present invention it is provided that data of the biometrical features of the individual recorded at every further identification and/or verification of the person are added as a further to n-th data set to the already existing data sets for this individual. With an increasing number of data sets the probability of error is reduced, as far as it is provided that every new data set which is recorded at the identification and/or verification of the individual is compared with a plurality and as a rule with all of the stored data sets of this individual. But it is also conceivable that a comparison of the data set which is to be recorded at the identification and/or verification is made only with some of the data sets which are selected at random.

According to a further feature of the invention it is provided that a data set which at every identification and/or verification of the individual has been judged as identical with and/or only slightly deviating from the data of the biometrical features to be recorded is deleted after the identification and/or verification of the individual. This prevents that too many identical data sets are stored in a data memory, so that an increasing number of identification operations requires more time for the arithmetical operations. Also the required storage capacity is thereby reduced, since by the method according to the invention identical data sets are recognized and half of them erased. Additionally, it may be provided that data sets are erased also after a certain time, for example when an initial period of frequent use by an individual is followed by a period of occasional use of the method. In this context it should be noted that the original data set of course remains preserved, so that the individual can be identified and/or verified also after a longer period of time.

Preferably, the deletion of data sets which are no longer required takes place after the identification and/or verification of an individual. This step of the method has the advantage that with the identification and/or verification of the individual also the signal for example for unlocking a lock is output and the individual may enter in a protected space. A computer system working with the method according to the invention thereafter has sufficient free computing capacity which is required for operations like the deletion of data sets or their processing. Accordingly, also this step of the method has the advantage that the required computing capacities remain within limits.

At the identification and/or verification of an individual comparing the data of the biometrical features of the individual recorded during the identification and/or verification of the individual at least with the original data set and at least with a further, second data set, particularly the last stored data set of the data of the biometrical features of the individual has proved itself as advantageous. With this feature of the method it is taken into account that between the original data set and the last generated and stored data set there may be a longer time interval which possibly favours alterations of the biometrical features.

According to a further feature of the invention it is provided that supplementary data of the biometrical features of the individual are added exclusively in a case where the data include deviations from the already stored first, second to n-th data sets. This embodiment only requires a small volume of memory, since with the method according to the invention a decision is made prior to storing the data set whether any such storing is necessary because of deviations. If it is determined that there are no deviations, the already stored data sets remain in the storage medium, without any updated data set being added. But it may be useful in this context, that in contrary thereto a new data set is also recorded when, though the same matches with the already stored data sets, the time interval between the last stored data set and the data set that is to be stored now has reached an extent which makes new storing appear appropriate. It is avoided thereby that biometrical features are left out of consideration which are not recognizable as alterations or deviations at the time of memorizing the data set which is to be stored, but which subsequently clearly show such alterations or deviations of the biometrical features.

To keep the storage capacity of a system for carrying out this method low, it has proved itself advantageous to memorize a number n of data sets for each individual to be identified and/or verified and at the time of collecting and/or storing the data set n+1 to replace the data set which has been stored first or a data set which is identical with the data set n+1 or which deviates the least from this data set by the data set n+1.

According to a further feature of the invention it is provided that the data of the biometrical features of the individual are compared with data that are stored, in particular invariably, in a second data memory that is read particularly through a data reading device. In this embodiment it has proved itself as advantageous that the second data memory is designed with the data as a component part of the identification means such as a machine-readable identification card, the data being stored preferably in a microchip or any other flat storage medium.

Accordingly, this further development of the invention provides that the identification and/or verification of the individual is not only performed by machine, but also by an inspection and examination of a machine-readable identification card. In this way any tampering with machine-readable IDs such as replacing the photograph can be readily detected if the data of biometrical features stored on the machine-readable ID do not match the biometrical features which are recorded at the same time from the individual to be identified and/or verified. Abuse of IDs for passing borders or also in social systems in connection with the paying out of income support in the form of unemployment money or social welfare can be substantially reduced thereby.

Preferably, in the second data memory further data for the identification and/or verification of an individual like name, date of birth, place of birth and/or place of residence are stored as text files and/or photographs as picture files in addition to the data relating to the biometrical features of the individual. Through the high volume of available data there is obtained a high probability of correct identification.

Finally, a method according to the invention provides that with every further identification of the individual a further data set is added to the original data set and/or to the last stored data set, respectively, and that this further data set is compared with the last stored data set and the original data set.

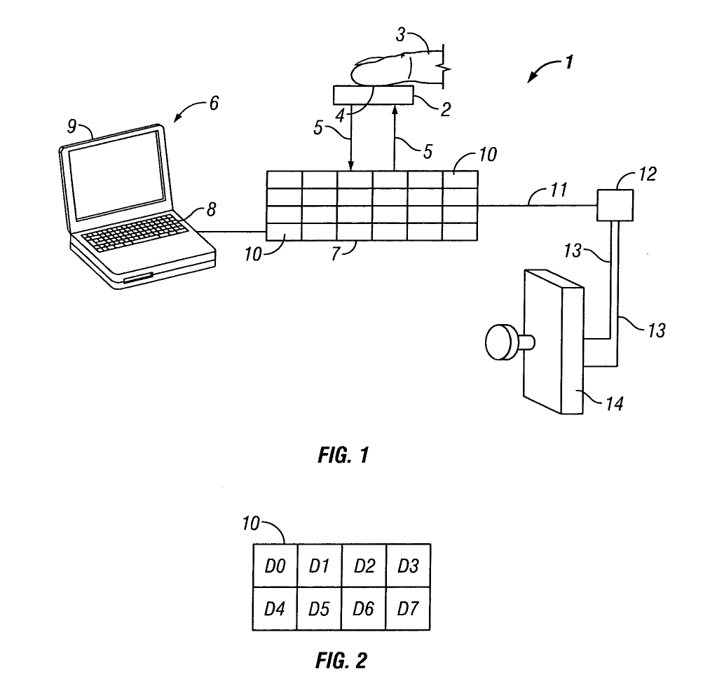

Further features and advantages will become evident from the following description of embodiments, wherein same parts carry the same reference numbers, and for similar features and functions reference is made to the description of the embodiment shown in FIG. 1. The drawings are schematic representations and merely serve for explaining the following embodiments.

In the drawings it is shown by:

FIG. 1 a first system for carrying out a method of identifying and/or verifying at least one individual, in a schematic view;

FIG. 2 a part of the memory of the system according to FIG. 2; and

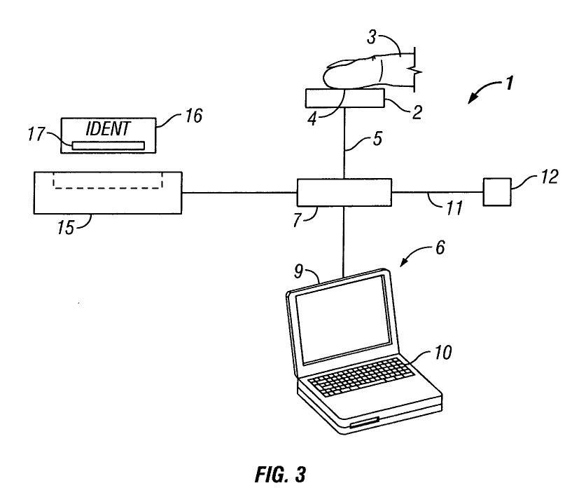

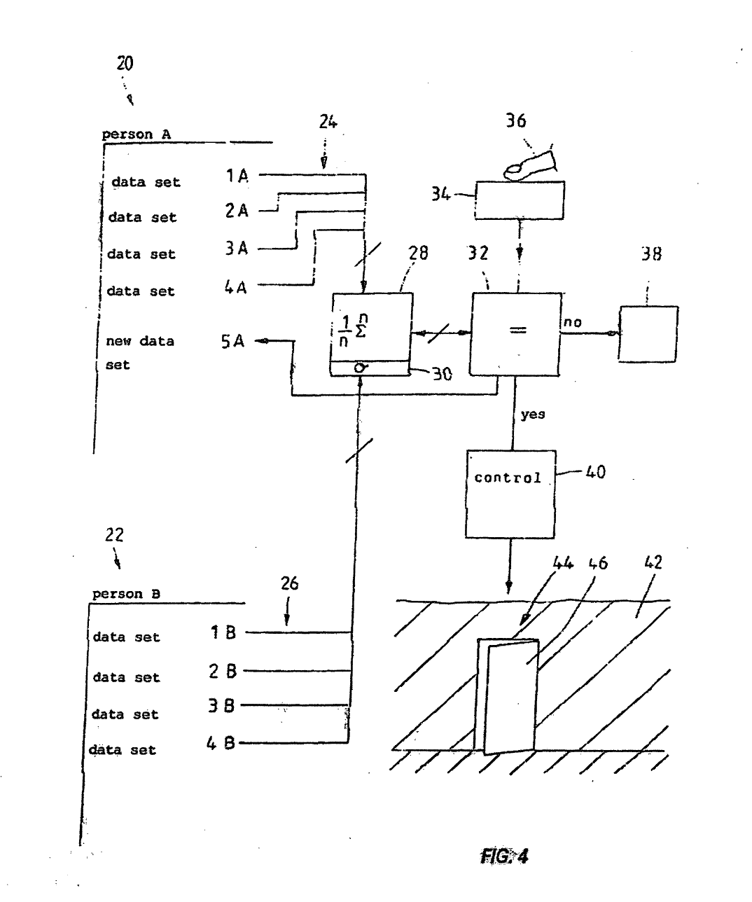

FIG. 3 a second embodiment of a system for the identification and/or verification of an individual; and

FIG. 4 a schematic flow chart of a method according to the invention.

A system 1 for carrying out the method of identification and/or verification of an individual in the course of checking an access authorization includes a reading device 2, by means of which fingerprints of fingers 3 can be recorded. The reading device generates an image of the biometrical features of the finger 3 within the region of its tip 4, and the biometrical features are sent through data lines 5 to a computer 6 including a data memory 7. The computer 6 consists of a keyboard 8 and a monitor 9 as well as central unit (not further shown) in which the data memory 7 is arranged.

The data memory 7 is subdivided in a plurality of units 10, each representing one section of the data storage 7 in which data sets UD, D1, D2, . . . DN of an individual are stored. Data set UD corresponds to an original data set which is generated through the initial recording of the biometrical features of the tip 4 of the finger 3 of the individual and which is stored as a reference value for the respective individual in the unit 10.

Connected to the data memory 7 through an additional data line 11 is a signal generator 12 that is connected to an electronic lock 14 through lines 13.

In FIG. 2 a unit 10 with data sets UD, D1, D2, D3, D4, D5, D6 and DN is shown. These data sets are assigned to a particular individual.

For carrying out the method according to the invention for the identification and/or verification of an individual it is provided that in a first step the original data set is generated and stored in the unit 10. Attention must be paid to the fact that the finger 3 with its tip 4 is correctly placed onto the reading device 2, so that an image as clear as possible may be produced from the biometrical features in the form of the data set UD. Any dirt particles that may be present on the fingertip 4 must be removed. Attention must be paid to possible injuries of the fingertip 4, so that an image produced from the biometrical features of the finger 3 is subsequently edited if this should be necessary because of existing injuries, before the data which are then produced are stored in the unit 10 as the data set UD.

The data of the original data set UD are filed as authorized for access, so that at a recognition of these biometrical data the electronic lock 14 is controlled via the signal generator 12 and is opened. To this end, the data are processed in the computer 6.

At every further recording of data representing the biometrical features of the tip 4 of the finger 3 a data set D1 to DN is generated which is compared with the original data set UD and in case with at least one further data set D1 to DN. If it is determined that the recorded data set matches with the original data set and/or a further stored data set D1 to DN and does not show major deviations, an individual will be verified as authorized for access and the electronic lock 14 will be unlocked via the signal generator 12.

This method provides that a tolerance value for minor alterations of the biometrical data is taken into account, so that dirt and/or injuries on the tip 4 of the finger 3 do not result in an exclusion of the access authorization, but in the grant of access to the respective individual. To this end, it is provided that every data set that is to be newly recorded is compared with a plurality of stored data sets UD, D1 to DN. When the storage capacity of unit 10 is exhausted, an already existing data set will be overwritten or replaced each time a data set is to be newly recorded, preferably selecting an identical data set or a data set with only minor differences from the original data set, as far as the data set with only minor differences from the original data set has verified the identification of the respective individual. In a similar manner the data set to be replaced can be selected under a time-based criterion by selecting the data set which has existed for the longest period of time. Of course, other solutions are also possible, according to which all parameters are used with the same or with a different weighting for selecting a data set that is to be overwritten.

In the second embodiment of a system 1 there is additionally provided a second reading device 15 for collecting data stored on a machine-readable identification card 16, and said reading device 15 is connected to the computer 6 through the data memory 7.

The identification card 16 includes a storage element 17, for example a chip, having stored in an invariable fashion data of an individual to be identified, e.g. biometrical features such as fingerprints, eye colour, eye background, DNA analyses. In addition to these data the machine-readable ID may include data for the identification of the individual such as name, date of birth, place of birth and/or place of residence as text files and/or photographs as picture files, of which a print copy can also exist in addition to being stored in the storage element 17. It is important in this context that the storage element 17 includes the biometrical features as data which are to be recorded from the individual to be identified also directly through the reading device 2.

Through the recording of the data of the biometrical features of the tip 4 of the finger 3 and simultaneously the data stored in the machine-readable identification card 16 a rapid identification and verification of an individual to be examined is possible. The system according to FIG. 3 is therefore particularly suited for use in areas where individuals have to be verified of their identity.

In both systems as shown above it is advantageous that through a varied use a self-learning system is created, of which the method according to the invention allows an increased accuracy of identification and verification of individuals by reading in supplementary data. Changes of the biometrical data can be readily taken into account, since the method according to the invention allows a higher probability of correct identification and verification through the plurality of data sets for each individual.

FIG. 4 schematically illustrates the flow of a process according to the invention. A memory unit (not further designated) with data fields 20 and 22 includes data sets 1A to 4A as well as 1B to 4B. These data sets are assigned to individuals A respectively B. They represent in the present case data sets for the fingerprint of the right thumb, and the numbering 1 to 4 of the data sets applies to data sets respectively collected from the same thumb during successive measurements. The individual data sets 1A to 4B can be supplied to an averaging device 28 via interrogation lines 24, 26. Connected to the averaging device 28 is a standard deviation generating device 30 which generates a standard deviation on the basis of the Gaussian distribution. The averaging device 28 is configured with regard to its function in such a way that it respectively uses the data sets 1 to 4 either of the individual A or of the individual B for forming an average value. The same applies for the standard deviation generating device 30. The results obtained form the averaging device 28 and from the standard deviation generating device 30 are sent to the comparator 32.

The sensor unit 34 detects the presence of a finger 36 and initiates the procedure for the detection of the authorization via functions and steps not further described. At the same time the sensor unit 34 detects a line profile of the finger 36 by scanning the finger 36 placed on a sensor surface (not further described) of the sensor unit 34 and generates from it a data set which is sent to the comparator 32.

The comparator 32 now requests data sets from the data base for comparison from the averaging device 28 and the standard deviation generating device 30, which data sets are used for the comparison. The averaging device 28 as well as the standard deviation generating device 30 generate a comparison data set from the data fields 20, 22 in a sequential form, beginning with the individual A. These data as generated by the averaging device 28 and the standard deviation generating device 30 are sent to the comparator 32 which on the basis of these data performs a comparison with the data set delivered from the sensor unit 34. The performance of this comparison is described for example in the document DE 101 18 485 A1, the disclosure thereof being included herein as a reference. The comparator 32 performs a comparison and determines whether identity exists between the data set of the averaging device 28 and the data set of the sensor unit 34. If this is the case, a command is output to the controller 40 controlling a built-in door 44 in a wall 42. If the comparator 32 delivers a positive signal, the door leaf 46 of the door 44 will be automatically opened through appropriate driving means not further shown. Moreover, the data set delivered from the comparator unit 34 is handed over to the data field 20 as a new data set 5A and is stored.

In the present case it is provided that for averaging and for generating the standard deviation only the data sets 1 to 4 of a data field 20, 22 are used. Therefore, it is provided that the earliest data set 1A is deleted and the following data sets 2A to 5A succeed in their order and form the new data sets 1A to 4A, as far as the finger 36 has been identified as belonging to the individual A. These then form the basis for the future process. The same applies also to further data fields, in this case for the data field of the individual B.

If it is determined by the comparator 32 that no identity exists between the data set from the averaging device 28 and the data set from the sensor unit 34, a range of tolerances is determined with the aid of the data of the standard deviation generator 30, and it is examined by the comparator unit whether the data set from the sensor unit 34 is to be established in the range of tolerances 34. In the positive case, a corresponding information is sent to the controller 40 as described above.

However, if the data set from the sensor unit 34 falls out of the range of tolerances, the averaging device 28 and the standard deviation generator 30 are caused to take the data field of a next individual, in this case the individual B, as basis for new comparison values. Then follows the procedure that has been described already before in connection with the data field 20.

If no data field leading to a positive decision of the comparator 32 can be found, the comparator 32 informs the output unit 38 which in the present case is an acoustic signal generator in the form of a buzzer. The same indicates that no authorization exists for the individual of finger 36. The controller 40 remains deactivated, so that the door leaf 46 of the door 44 remains shut.

The embodiments shown in the figures are merely for illustrating the invention and are by no means limiting. So variations are possible especially with regard to the form of the comparison operations, the mathematical functions that are used and so on.

### LIST OF REFERENCE NUMBERS

1 system
2 reading device
3 finger
4 finger tip
5 data lines
6 computer
7 data memory
8 keyboard
9 monitor
10 unit
11 data line
12 signal generator
13 line
14 lock
15 reading device
16 identification card
17 storage element
20 data field
22 data field
24 interrogation line
26 interrogation line
28 averaging device
30 standarddeviation generator
32 comparator
34 sensor unit
36 finger
38 acoustic signal generator
40 controller
42 wall
44 door
46 door leaf

1. Method for the determination of an authorization, using at least one biometrical feature, wherein the biometrical feature is collected by means of a sensor unit and is compared with data sets assigned to individuals and stored for this feature and leads to a result of the comparison which allows a decision on the presence of the authorization,
characterized in
that at a positive decision on the presence of the authorization the data of the detected biometrical feature are stored as a data set, particularly as a further data set changed or unchanged and related to individuals.

2. Method according to claim 1, characterized in that the data of the collected biometrical feature are compared with several data sets of an individual which are stored for this feature.

3. Method according to claim 1, characterized in that one data set for this feature is deleted.

4. Method according to one of the claims 1 to 3, characterized in that the deletion of the data set is dependent of a match at the comparison with the collected biometrical feature.

5. Method according to one of the claims 1 to 4, characterized in that one data set for a biometrical feature is replaced in a fashion related to the individual by a replacement data set of a currently collected biometrical feature.

6. Method according to one of the claims 1 to 5, characterized in that the earliest individual-related data set is replaced by the replacement data set.

7. Method according to claim 5 or 6, characterized in that the replacement data set is composed of the data set to be replaced and the data set of the collected biometrical feature.

8. Method according to one of the claims 1 to 7, characterized in that from several data sets available for this feature a data set for the comparison is determined.

9. Method according to one of the claims 1 to 8, characterized in that a number of individual-related data sets is limited.

10. Method according to one of the claims 1 to 9, characterized in that the data set of the collected biometrical feature is compared with an invariable data set of a separate storage unit.

11. Method according to one of the claims 1 to 10, characterized in that a transportable storage unit is used as a separate storage unit.

12. Method according to one of the claims 1 to 11, characterized in that an initializing data set is stored in an individual-related fashion.

13. Method according to one of the claims 1 to 12, characterized in that from several data sets available for this feature a range of acceptance is determined.

14. Method according to one of the claims 1 to 13, characterized in that the comparison takes place on the basis of the range of acceptance.

15. Method according to one of the claims 1 to 14, characterized in that the range of acceptance is adapted by means of the detected biometrical feature after a match has been determined at the comparison.

16. Method according to one of the claims 1 to 15, characterized in that as a biometrical feature a biometrical feature of a human being is used.

17. Method according to one of the claims 1 to 16, characterized in that it is used for a lock control.

18. Method according to one of the claims 1 to 17, characterized in that it is used for the identification and/or verification, particularly for the examination of an access and/or operation authorization of at least one individual through a comparison of biometrical features of the individual, particularly at least one of its fingerprints and/or at least one iris with data of the biometrical features of the individual stored in a memory, in which method the data of the biometrical features of the individual are stored as a first data set in a data memory and the data of the first data set are compared at every identification and/or verification with the data recorded during the identification and/or verification, in order to generate a signal indicating match or non-match of the recorded data with the data of the stored first data set, wherein the data of the biometrical features of the individual recorded during the identification and/or verification are stored in the data memory as data of a second data set of the biometrical features of the individual in addition to the already existing first data set and that at every subsequent identification and/or verification of the individual the biometrical data recorded during the identification and/or verification are compared with at least the data of a one of the stored first and/or second data sets, in particular with the last stored second to n-th data set.

19. Method according to claim 18, characterized in that the originally stored data of the biometrical features of the individual are stored as an original data set invariably and particularly non-erasable in the data memory.

20. Method according to claim 18, characterized in that data of the biometrical features of the person recorded at every further identification and/or verification of the person are added to the already existing data sets for this person as a further to n-th data set.

21. Method according to claim 18, characterized in that the data of the biometrical features of the person recorded at every identification and/or verification of the person are compared with all of the stored data sets including data of the biometrical features of this person.

22. Method according to claim 18, characterized in that a data set which at every identification and/or verification of the person is judged as a data set which is identical with and/or only slightly deviating from the data of the biometrical features of the data to be recorded is deleted after the identification and/or verification of the person.

23. Method according to claim 22, characterized in that the deletion of data sets which are no longer needed is effected after the verification of the identity of the person.

24. Method according to claim 19, characterized in that the data of the biometrical features of the person recorded during the identification and/or verification of the person are compared at least with the original data set and with at least one further, second data set, particularly at least the last stored data set of the data of the biometrical features of the person.

25. Method according to claim 18, characterized in that supplementary data of the biometrical features of the person are exclusively added when the data are deviating from the already stored first, second to n-th data sets.

26. Method according to claim 18, characterized in that in connection with each person to be identified a number of n data sets are stored and that at the collection and/or storing of the data set n+1 the data set which, in terms of time, has been stored first or a data set which is identical with or which deviates the least from the data set n+1 is replaced by the data set n+1.

27. Method according to claim 18, characterized in that the data of the biometrical features of the person are compared with data which are stored, especially invariably, in the second data memory which is read particularly through a data reading device.

28. Method according to claim 27, characterized in that the second data memory is designed with the data as a component part of an identification means, for example a machine-readable identification card, said data being stored preferably in a microchip or an other flat storage medium.

29. Method according to claim 27, characterized in that in the second data memory there are stored in addition to the data relating to biometrical features of the person further data for identification, such as name, date of birth, place of birth and/or place of residence as text files and/or photographs as picture files.

30. Method according to claim 19, characterized in that to the original data set and/or the last stored data set is respectively added a further data set, with every further identification and/or verification of the person, and that the further data set is compared at least with last stored data set and with the original data set.
